(19) United States
(12) Patent Application Publication
(10) Pub. No.: US 2015/0052450 A1
(43) Pub. Date: Feb. 19, 2015

(54) Displaying Hierarchies of Artifacts

(71) Applicant: Mimecast North America Inc., Waltham, MA (US)

(72) Inventors: David Goldberg, Sherborn, MA (US); Glenn Brown, London (GB); Carl Thevenin, Lynn, MA (US)

(21) Appl. No.: 13/965,529

(22) Filed: Aug. 13, 2013

(51) Int. Cl. G06F 3/0484; H04L 12/58

(52) U.S. Cl. CPC G06F 3/0484; H04L 51/22
USPC 715/752; 715/853

(57) ABSTRACT

Among other things, we describe receiving, from a user, a first criterion for arranging a set of artifacts in a first hierarchy including a first arrangement, the artifacts being stored in an archive in a second arrangement, and displaying, in a user interface, a level of the first hierarchy including a subset of the artifacts, the subset of the artifacts having a common feature identified based on the first criterion.

### BACKGROUND

This description relates to the displaying hierarchies of artifacts. Computers can be used to store, organize, and display artifacts in various ways.

### SUMMARY

The electronic file management that we describe here may encompass one or more of the following (and other) aspects, features, and implementations, and combinations of them.

In general, in an aspect, a computer-implemented method includes receiving, from a user, a first criterion for arranging a set of artifacts in a first hierarchy including a first arrangement, the artifacts being stored in an archive in a second arrangement, and displaying, in a user interface, a level of the first hierarchy including a subset of the artifacts, the subset of the artifacts having a common feature identified based on the first criterion.

Implementations of this aspect may include one or more of the following features. The method includes receiving from the user a second criterion for arranging the set of artifacts in a second hierarchy including a second arrangement, and displaying, in the user interface, a level of the second hierarchy including a second subset of the artifacts, the second subset of the artifacts having a common feature identified based on the second criterion. The method includes receiving, from the user, a plurality of criteria for arranging the set of artifacts in a plurality of corresponding levels of the first hierarchy, each level including a different arrangement of the artifacts, and displaying, in the user interface, one of the levels of the first hierarchy including a subset of the artifacts, the subset of the artifacts having a common feature identified based on one of the plurality of criteria. The first criteria is among the plurality of criteria. The level of the hierarchy is displayed in the form of a directory, the directory comprising a portion of a logical drive available to a computer system operated by the user. The set of artifacts includes a set of email messages and attachments each associated with at least one of the email messages. The first hierarchy includes a directory structure of folders and files stored within the respective folders, the files including at least some of the artifacts of the set of artifacts. The common feature is identified based on identifying similarities among metadata associated with the respective artifacts of the subset, the metadata including data other than data describing a storage location of the respective artifacts. The common feature is identified based on an identification of semantic similarities among content of the respective artifacts. The common feature is identified based on a combination of semantic similarities among the content of the respective artifacts and similarities among metadata associated with the respective artifacts of the subset, the metadata including data other than data describing a storage location of the respective artifacts. The first hierarchy includes a plurality of levels, where each level corresponds to a different characteristic of the first criterion. The level of the hierarchy is displayed in the form of a hierarchical outline.

In general, in another aspect, computer readable media storing software includes instructions executable by a computer system to cause the computer to perform operations including receiving, from a user, a first criterion for arranging a set of artifacts in a first hierarchy including a first arrangement, the artifacts being stored in an archive in a second arrangement, and displaying, in a user interface, a level of the first hierarchy including a subset of the artifacts, the subset of the artifacts having a common feature identified based on the first criterion.

Implementations of this aspect may include one or more of the following features. The operations additionally include receiving from the user a second criterion for arranging the set of artifacts in a second hierarchy including a second arrangement, and displaying, in the user interface, a level of the second hierarchy including a second subset of the artifacts, the second subset of the artifacts having a common feature identified based on the second criterion. The operations additionally include receiving, from the user a plurality of criteria for arranging the set of artifacts in a plurality of corresponding levels of the first hierarchy, each level including a different arrangement of the artifacts, and displaying, in the user interface, one of the levels of the first hierarchy including a subset of the artifacts, the subset of the artifacts having a common feature identified based on one of the plurality of criteria. The first criteria is among the plurality of criteria. The level of the hierarchy is displayed in the form of a directory, the directory comprising a portion of a logical drive available to a computer system operated by the user. The set of artifacts includes a set of email messages and attachments each associated with at least one of the email messages. The first hierarchy includes a directory structure of folders and files stored within the respective folders, the files including at least some of the artifacts of the set of artifacts. The common feature is identified based on identifying similarities among metadata associated with the respective artifacts of the subset, the metadata including data other than data describing a storage location of the respective artifacts. The common feature is identified based on an identification of semantic similarities among content of the respective artifacts. The common feature is identified based on a combination of semantic similarities among the content of the respective artifacts and similarities among metadata associated with the respective artifacts of the subset, the metadata including data other than data describing a storage location of the respective artifacts. The first hierarchy includes a plurality of levels, where each level corresponds to a different characteristic of the first criterion. The level of the hierarchy is displayed in the form of a hierarchical outline.

In general, in another aspect, a system includes a computer system configured to receive, from a user, a first criterion for arranging a set of artifacts in a first hierarchy comprising a first arrangement, the artifacts being stored in an archive in a second arrangement; and display, in a user interface, a level of the first hierarchy including a subset of the artifacts, the subset of the artifacts having a common feature identified based on the first criterion.

Implementations of this aspect may include one or more of the following features. The system additionally receives from the user a second criterion for arranging the set of artifacts in a second hierarchy including a second arrangement, and displays, in the user interface, a level of the second hierarchy including a second subset of the artifacts, the second subset of the artifacts having a common feature identified based on the second criterion. The system additionally receives, from the user a plurality of criteria for arranging the set of artifacts in a plurality of corresponding levels of the first hierarchy, each level including a different arrangement of the artifacts, and displays, in the user interface, one of the levels of the first hierarchy including a subset of the artifacts, the subset of the artifacts having a common feature identified based on one of the plurality of criteria. The first criteria is among the plurality of criteria. The level of the hierarchy is displayed in the form of a directory, the directory comprising a portion of a logical drive available to a computer system operated by the user. The set of artifacts includes a set of email messages and attachments each associated with at least one of the email messages. The first hierarchy includes a directory structure of folders and files stored within the respective folders, the files including at least some of the artifacts of the set of artifacts. The common feature is identified based on identifying similarities among metadata associated with the respective artifacts of the subset, the metadata including data other than data describing a storage location of the respective artifacts. The common feature is identified based on an identification of semantic similarities among content of the respective artifacts. The common feature is identified based on a combination of semantic similarities among the content of the respective artifacts and similarities among metadata associated with the respective artifacts of the subset, the metadata including data other than data describing a storage location of the respective artifacts. The first hierarchy includes a plurality of levels, where each level corresponds to a different characteristic of the first criterion. The level of the hierarchy is displayed in the form of a hierarchical outline.

These and other aspects, features, and implementations, and combinations of them, may be expressed as apparatus, methods, methods of doing business, means or steps for performing functions, components, systems, program products, and in other ways.

Other aspects, features, and advantages will be apparent from the description and the claims.

### DESCRIPTION

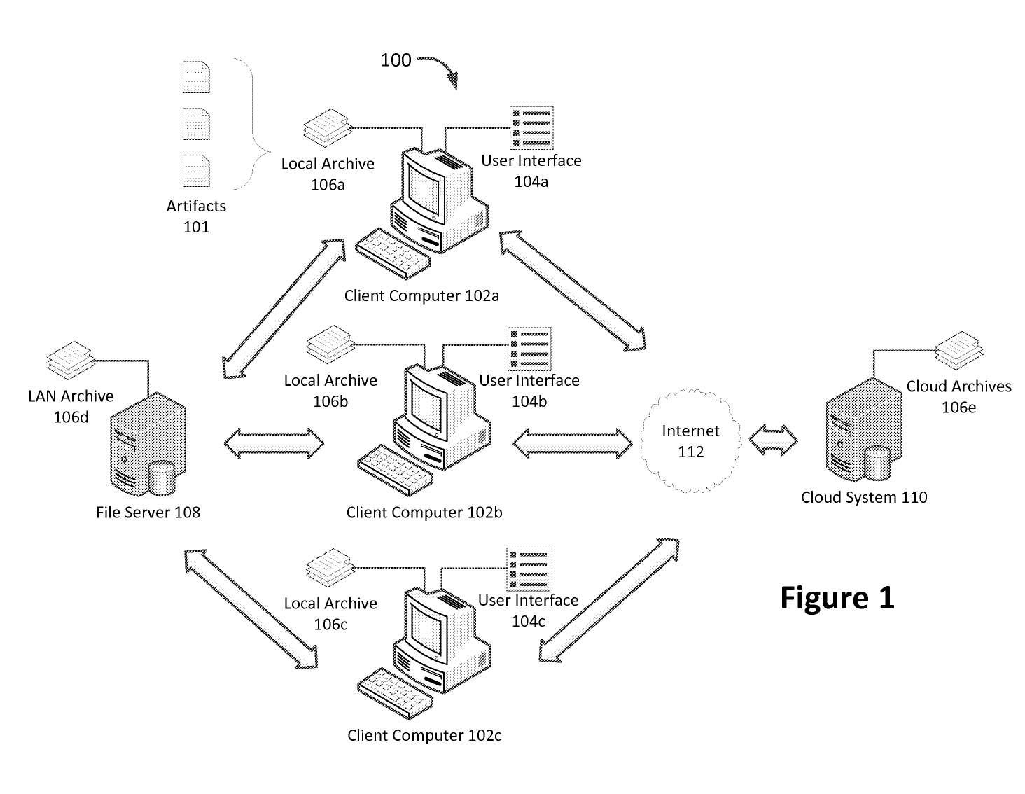

FIGS. 1, 2, 5, 7, and 9 are block diagrams.

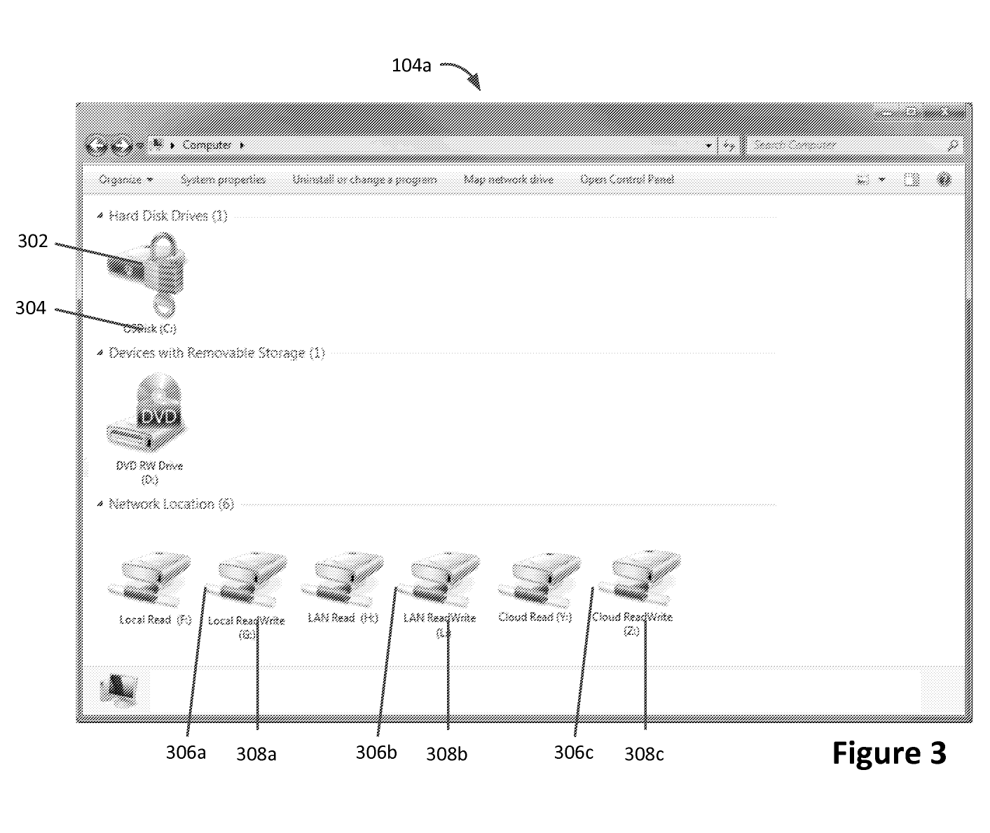

FIGS. 3, 4A, 4B, 4C, 6A, 6B, and 8A, 8B, 8C are examples of user interfaces.

A file management application enables a user to access, manipulate, and share artifacts (e.g. portions of data) stored by one or more storage facilities. A storage facility could be a physical entity such as a file system on a hard drive of a computer. A storage facility could also be a distributed entity such as a “cloud”-based storage facility. A cloud-based facility can typically be accessed by many users over a network such as the Internet, and allows those users to access stored data from anywhere on the network.

The file management application may store artifacts according to one or more of several possible types of file structures. For instance, a file management application may store artifacts with respect to one or more hierarchical directories. Artifacts may be grouped into one of several directories, copied to one or more other directories, moved between different directories, or deleted from the file structure altogether. A directory-based file structure may be flat (so that artifacts are organized into a single hierarchical level of directories), or may have an arbitrary number of levels (so that each directory can contain one or more nested subdirectories with an arbitrary number of hierarchy levels). In typical use, a directory may be used to categorize the artifacts and/or subdirectories contained within it.

A file management application may also display artifacts to a user, such that the user can locate and access a particular artifact within the file structure. In some examples, the storage and the display of files could be related. For instance, artifacts within the file structure may be viewed using a navigation interface that emulates the hierarchical organization of a directory-based file structure. In an example interface, each directory of the file structure is represented as a branch in a navigational tree, with each nested subdirectory represented by further branches of the navigational tree. Thus, a user wishing to access a particular artifact may navigate through a series of directories and subdirectories until he reaches the branch representing the storage location of the artifacts within the file structure.

The display of files need not be directly related to the manner in which they are stored. For instance, artifacts within a file structure may be viewed using a hierarchical navigation interface, but may be arranged according to a viewing structure (e.g., an organizational structure as presented to a user) that is dynamically generated based on one or more criteria. By “dynamically generated,” we mean that the viewing structure can be generated anew as needed, e.g., in response to a user request. In contrast, a viewing structure that is not dynamically generated may be generated in advance.

The user-specified organizational criteria may be based on explicit data within the document or source (i.e. metadata properties, date of creation, sender information, file type, etc.), implicit data derived from the content of the document or source (i.e. subject matter of the document, inferred importance of a communication, mood of the communication, etc.) or a combination of both explicit and implicit data or other kinds of data. Implicit data may be determined algorithmically based on the contents of the document or source, for instance through natural language interpretation techniques.

In some examples, the hierarchy of the viewing structure is selectable by the user, and may be modified at any time to revise the presentation of the artifacts. The number of levels of hierarchy is also selectable, and may be increased or decreased depending on the number of characteristics that the user wishes to consider. Further, specific sets of hierarchies may be saved in the form of templates, such that a user may quickly switch between two or more preferred hierarchies.

As an example, a set of artifacts might be viewed as organized in a hierarchy of levels, such that the first level is artifact author, the second level is year of creation of the artifact, the third level is month of creation of the artifact, and then the lowest level is file type of the artifact. This would appear to a user as if the artifacts had been stored in a hierarchical file structure, with a first level of directories representing different authors, the second level of directories representing different years, and so on. The user could then issue a command to restructure the hierarchy into a form in which the top level directories were based on customer names, the next level on author, etc. The organization and sorting can be based on any type of metadata or content data of the artifacts. In this manner, the user may alter the presentation of the artifacts within the viewing structure without changing the storage location of the artifacts within the file structure.

As another example, an archive could contain audio files, in addition to, or instead of other types of documents. The hierarchy could first represent an organization in which the top level directories were “Jazz,” “Rock,” etc. Upon receiving a command from the user, the hierarchy could then be reorganized so that the top level directories were the artists' names, the next level represented albums, etc. The audio files could all be pulled from attachments to emails, for example, if an audio producer who frequently emails his or her work just wanted to view the audio files in his or her email archive. In the case of email, the manner in which the data are displayed can be chosen based on email headers, email metadata like tags, contents of emails, contents of attachments, etc. In some implementations, audio files are displayed alongside other types of documents, for example alongside text documents, images, and/or emails. When we use the term artifact, we mean it in a very broad sense, to include, for example, any portion or fragment of data, e.g., that forms an electronic communication. A file management application enables a user to access, manipulate, share and in other respects to use artifacts. We refer to any of these types of activities and to any other use of artifacts broadly as “interacting” with or “using” artifacts. Any portion of data, such as any portion of an electronic communication, can be an artifact. Anything sent and received by a user of one of the applications can be an artifact. For example, an email message is an artifact. An email message typically has a topic (sometimes denoted by a “subject” field) and contains content written by a user about the topic. An email message can also relate to multiple topics. A portion that is less than all of an email can also be an artifact.

An email message has at least one recipient, and may have many recipients who are either individual users or groups of users (e.g., a mailing list of users). An email message could also contain multiple artifacts. For example, one portion of an email message body could be an artifact, and another portion (e.g., a portion relating to a different topic) could be a different artifact. An attachment to the email message could be yet another artifact, as could an in-line image within the email message.

As another example, a posting on a social networking service, or a portion of a posting, is an artifact. A posting on a social networking service is typically composed by a user and relates to a topic of interest by the user. The posting may be available to all other users linked to the user, or the posting may be available to only select users, or the posting may be available to all users of the social networking service, or the posting may be available to some other category or categories of users.

As another example, a portion of a real-time conversation is an artifact. For example, a real-time communication system, such as an instant messaging system that enables users to exchange short messages in real time, may be used to facilitate and record a series of messages related to a topic or multiple topics being discussed by users of the instant messaging system. The conversation may be held between two or more users; i.e., two or more users may participate in a single conversation, sometimes referred to as a single session. A transcript of messages exchanged in a single session may include one or more artifacts. Each message may be an artifact, a portion of the conversation (e.g., a portion relevant to a particular topic), or the entirety of the conversation may be an artifact.

As another example, data stored as files on a file system are artifacts. Data may include one or more types of information, such as textual data (e.g. text documents such as letters, memos, reports, tables, spreadsheets, etc.), image data (e.g. photographs, illustrations, etc.), audio data (e.g. recorded music, speech, and other auditory information), video data, or combinations of one or more types of information (e.g. illustrated documents, multimedia presentations, annotated videos, etc.) Files may be stored individually on a file system, or may be stored in combination with other files in one or more file repositories or archives.

Other types of data that can be artifacts include syndication feeds (e.g., RSS feeds), voice data or other kinds of audio (e.g., recorded telephone calls, voice messages such as voicemail, transcripts of a spoken conversation, audio feeds, etc.), and video (recorded video calls, video mail or video messages, security cameras, video feeds, etc.).

When we use the term cloud system, we mean it in a very broad sense, to include, for example, any remote system of storing, maintaining, and processing data. For example, in some examples a cloud system may be a computing device such as a server or a data storage facility that includes multiple servers. The cloud system may be any other kind of system that can store, send, and receive data.

When we use the term archive, we mean it in a very broad sense, to include, for example, any grouping of one or more artifacts. In some implementations, an archive is a collection of artifacts stored according to a particular storage structure. For example, an archive may be a collection of artifacts stored within one or more container files (e.g. compressed container files, uncompressed container files, or a combination of compressed and uncompressed container files). In another example, an archive may be one or more directories containing one or more artifacts. In another example, an archive may be a combination of one or more directories, and one or more container files. In some implementations, archives may be stored on one or more storage facilities.

FIG. 1 is a block diagram of a system 100 that allows users to interact with artifacts 101 stored on one or more storage facilities. A user interacts with a user interface 104a-c of one or more client computers 102a-c to access artifacts 101 stored in one or more file archives 106a-e. In some examples, the archives 106a-e may be maintained on any number of communicatively networked modules (by which we mean modules in communication with each other using a network as a communications medium). As an example, an archive 106a can be locally maintained on a client computer 102a, and archives 106b and 106c can be maintained on other client computers 102b and 102c, respectively. The client computers 102a-c may be communicatively networked, for instance through a local area network (LAN) or a wide area network (WAN), such that information can be transferred between client computers 102.

In addition, archives can be stored on one or more server modules. For example, an archive 106d can be maintained on a file server 108. The file server 108 may be communicatively networked to client computers 102, for example through a LAN or a WAN. The file server 108 may be devoted predominantly to managing access to archive 106d (i.e. a dedicated network file server), or may process other operations in conjunction with file management (i.e. a general network server).

Further, archives can be stored on one or more “cloud” modules, e.g., systems such as file systems. For example, an archive 106e can be maintained on a cloud file system 110. The cloud system 110 may be communicatively networked to client computers 102, for example through communications routed through a LAN or a WAN, for example through the Internet 112. The cloud system 110 may also be networked to client computers 102, either additionally or alternatively, through a separate LAN or WAN communication connection.

In some examples, a cloud system need not be located locally to a client's system, nor under direct control of a client. For instance, a cloud system may be located at a physical location under the control to a third party service provider, rather than located at a physical location under the control of a client. If a cloud system is a distributed system including multiple servers, the cloud system may be located at several physical locations under the control of a third party, or the client, or a combination of the two. In some examples, the cloud system or portions of the cloud system could be located at one or more physical locations that are hundreds or thousands of miles away from any resource of a client.

In some implementations, a portion of the cloud system may be operated by an entity other than a service provider directly contracted by a client. For example, a service provider may hire a subcontractor to maintain a portion of the cloud system. In some implementations, a service provider has control over the entire cloud system, including portions operated by another entity.

In some examples, a user may interact with a client computer 102 to access combinations of one or more archives 106a-e. As an example, a user interacting with a client computer 102a may use a user interface 104a to access a locally maintained archive 106a and an archive 106d on file server 108. In another example, a user interacting with a client computer 102b may use another user interface 104b to access a locally maintained archive 106b, an archive 106c on a client computer 102c, and an archive 108e maintained on a cloud server 110. In this manner, a user may use his or her client computer 102 to access artifacts stored on any number and combinations of networked components.

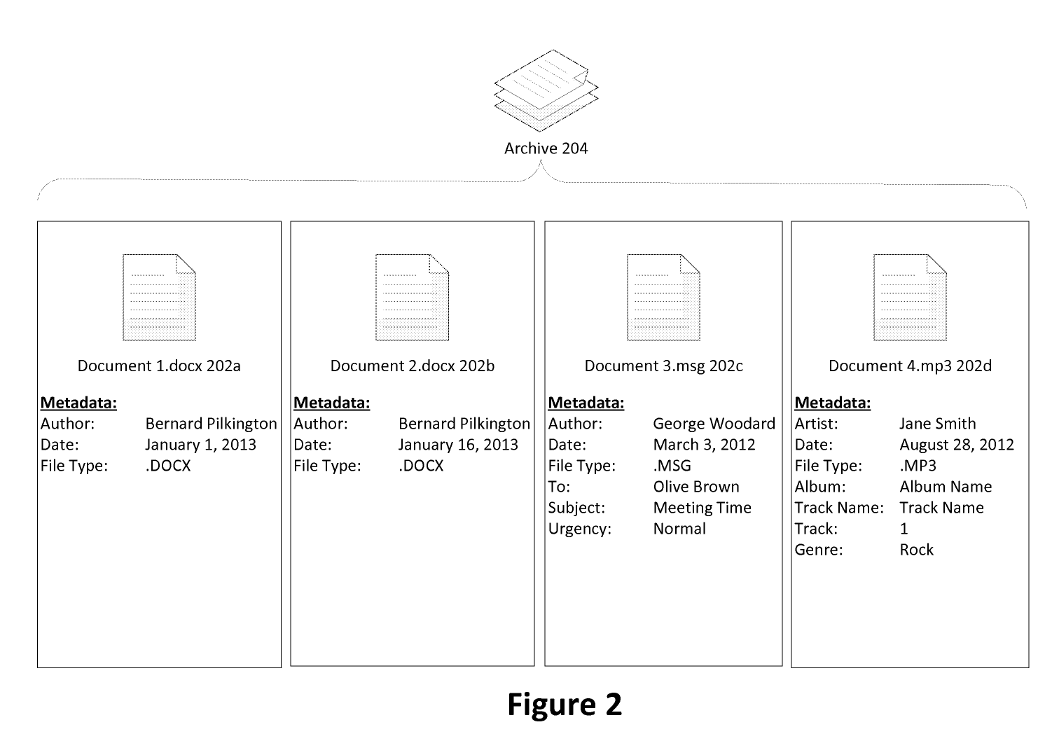

In some examples, one or more artifacts can be stored within one or more archives on one or more storage facilities. FIG. 2 shows an example of four artifacts 202a-d stored within an archive 204. Several different types of artifacts may be stored within the same archive. For example, the archive 204 includes artifacts of differing file types, including documents (202a-b), e-mail messages (202c), and audio (202d). In some examples, each artifact includes metadata that describes one or more properties of the artifact. For example, an artifact 202a that represents a document may contain metadata that specifies the author of the document, the date that the document was created, and the file type of the artifact. In another example, an artifact 202c that represents an email message may contain metadata that specifies the author of the message, the date that the message was sent, the recipient of the message, the subject of the message, and the urgency level of the message. In another example, an artifact 202d that represents an audio recording may contain metadata that specifies the name of the musical artist that created the recording, the date that the recording was made, the name of the musical album from which the recording originated, the name of the recording, the number of the recording within the musical album, and the genre of the recording. While specific examples of metadata are described above, metadata can describe any property of an artifact, and are not limited by the above examples.

FIG. 3 shows an example of a user interface 104a used to access one or more archives 106a-e. The user interface 104a may represent artifacts and archives through the use of icons and labels within a graphical user interface (GUI). For example, an icon 302 and a label 304 can be used to represent a file system of a storage device physically located on a user's computer. In a similar manner, an icon 306a and a label 308a can be used to represent an archive maintained locally on a client's computer (for instance an archive 106a stored on client computer 102a), an icon 306b and a label 308b can be used to represent an archive maintained on a file server (for instance an archive 106d stored on a file server 108), and an icon 306c and a label 308c can be used to represent an archive maintained on a cloud system (for instance an archive 106e stored on a cloud system 110).

In some examples, each of the archives may be “mounted” or “mapped” to a file system native to the client computer, such that the archive can be directly accessed through the client computer's native file system, e.g., as if the archive were a local disk drive or other local facility. As an example, each archive may be assigned a logical label (for instance, a unique drive letter), such that the archive is represented as a unique entity within the native file system. Thus, an archive maintained locally on a client's computer may have a unique logical label 308a (for instance “G”), an archive maintained on a file server may have a unique logical label 308b (for instance, “L”), and an archive maintained on a cloud system may have a unique logical label 308c (for instance, “Z”). In some implementations, one or more archives may be represented by a single logical label. In this manner, archives may be referred to and accessed according to the labeling conventions of the client's computer.

The user interface 104a may represent an archive in different ways. For instance, in some implementations, the user interface 104a represents an archive with a corresponding icon and label. In some implementations, the user interface 104a represents an archive with only an icon, or with only a label. In some implementations, the user interface 104a represents archives in a hierarchical outline. In some implementations, the user interface 104a may represent individual archives in different ways, for instance by representing some archives with icons and labels, other archives with icons only, and other archives with labels only.

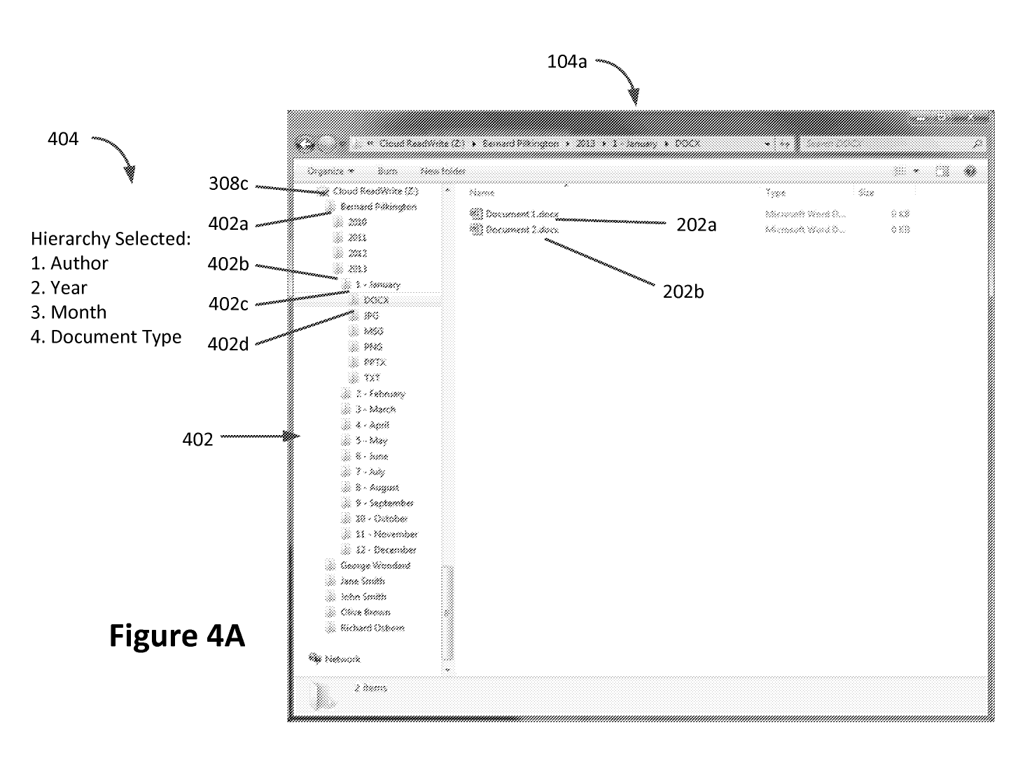

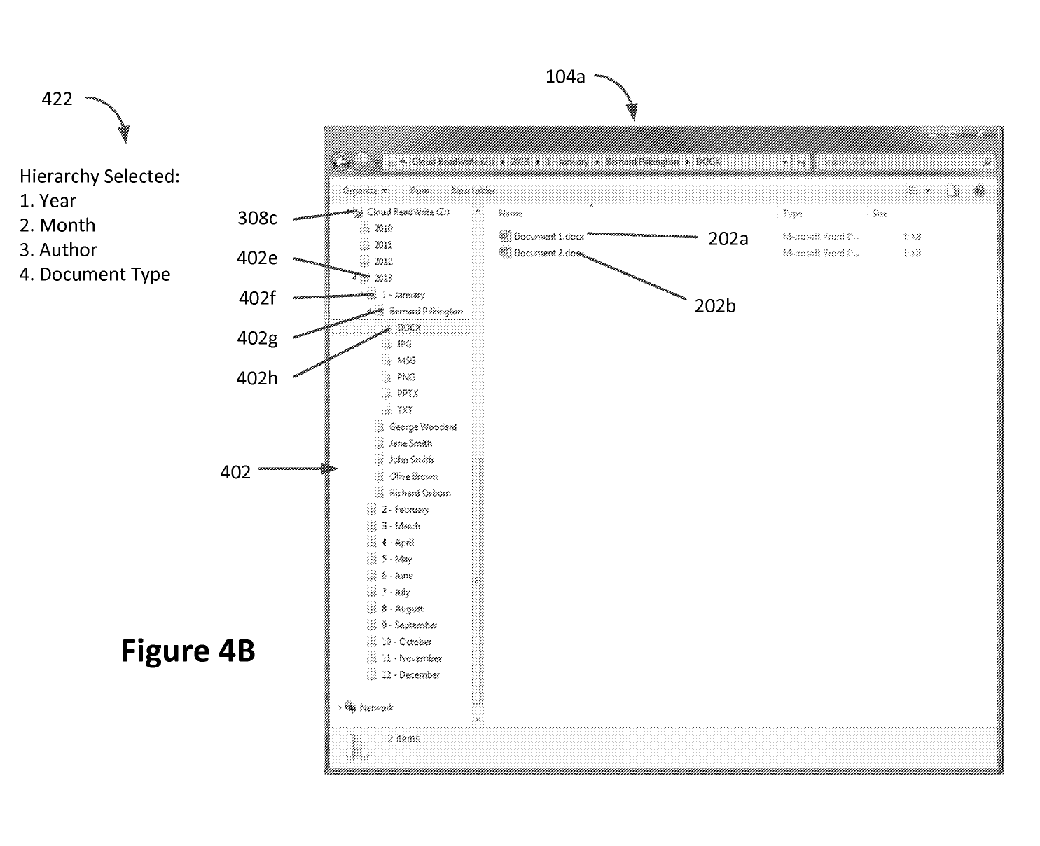

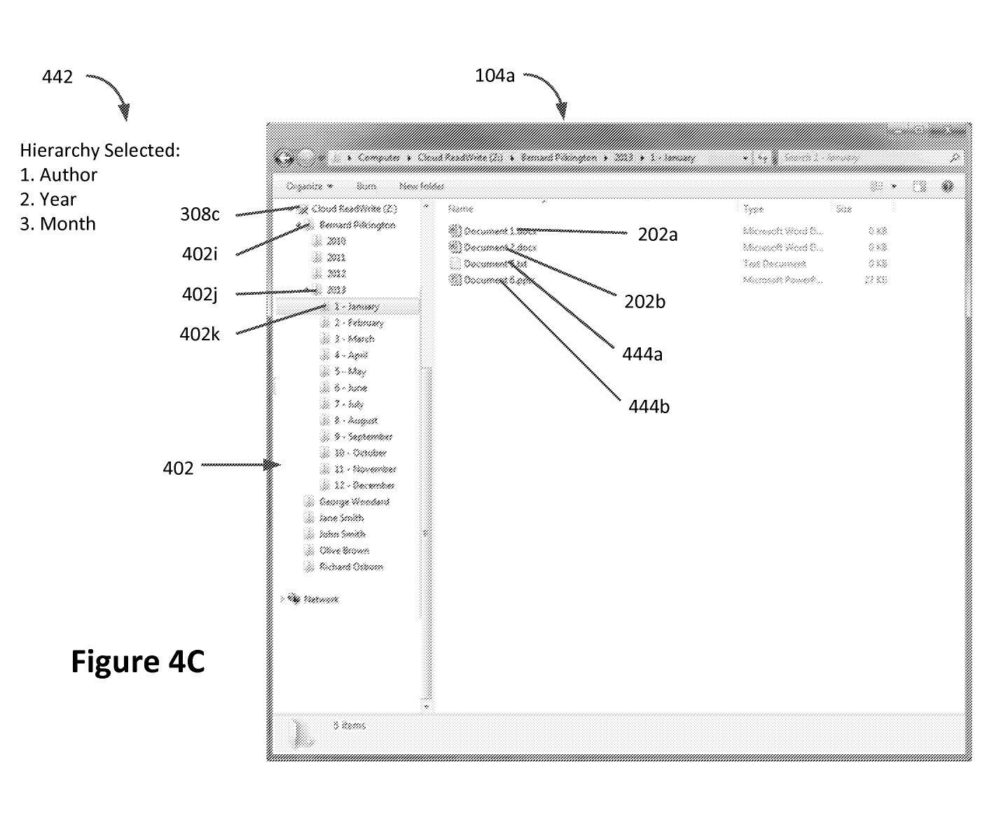

FIG. 4A shows an example of a user interface 104a used to access the contents of one or more archives 106a-e. The user interface 104a may display artifacts with respect to a particular viewing structure, where the viewing structure includes one or more hierarchical directories 402. For example, the artifacts 202a-b may be visually represented within a nested arrangement of hierarchical directories 402a-d, where each hierarchical directory 402a-d is on a different hierarchy level.

The viewing structure may be dynamically generated based on user selected viewing criteria, such that the hierarchical directories 402 and the location of the artifacts within the directories are dynamically generated. For instance, a user may specify a viewing criterion 404 in which a first hierarchical level represents authors of artifacts, the second hierarchical level represents the creation year of artifacts, the third hierarchical level represents the creation month of artifacts, and the fourth hierarchical level represents the file type of artifacts. In this way, a user wishing to access an artifact 202a stored within an archive 204 may navigate through a series of directories and subdirectories, first by selecting the logical label 308c representing the archive 204, then by selecting a directory 402a representing the author of the artifact 202a, then by selecting a subdirectory 402b representing the year that the artifact 202a was created, then by selecting a subdirectory 402c representing the month that the artifact 202a was created, then by selecting a subdirectory 402d representing the file type of the artifact 202a. As another artifact 202b shares the same author, creation year, creation month, and file type as the artifact 202a, the other artifact 202b is displayed in the same hierarchical location as artifact 202a. In this manner, the user navigates the user interface 104a as if artifacts were stored in a hierarchical file structure, where each successive directory filters files according to progressively narrower criteria.

In some implementations, the user may issue a command to restructure the viewing structure based on another user selected viewing criterion, such that the hierarchical directories 402 and the location of the artifacts within the directories are dynamically re-generated. For instance, referring to FIG. 4B, a user may specify another viewing criterion 422, where a first hierarchical level represents the creation year of artifacts, the second hierarchical level represents the creation month of artifacts, the third hierarchal level represents authors of artifacts, and the fourth hierarchical level represents the file type of artifacts. Thus, a user wishing to access the artifact 202a stored within an archive 204 may navigate through the restructured series of directories and subdirectories, first by selecting the logical label 308c representing the archive 204, then by selecting a directory 402e representing the year that the artifact 202a was created, then by selecting a subdirectory 402f representing the month that the artifact 202a was created, then by selecting subdirectory 402g representing the author of the artifact 202a, then by selecting a subdirectory 402h representing the file type of the artifact 202a. As another artifact 202b shares the same author, creation year, creation month, and file type as the artifact 202a, the artifact 202b is displayed in the same hierarchical location as the artifact 202a.

In some examples, while the viewing structure may be dynamically generated based on user selected viewing criteria, the storage location of each artifact within the archive is not altered upon each re-generation. Thus, while the user interface 104a displays artifacts as if they were stored in different locations within the hierarchical file structure after each re-generation, each artifact remains in the same storage location within its archive. In this way, the viewing structure is independent of the storage location.

The number of levels of hierarchy is also user selectable, and may be increased or decreased depending on the number of characteristics that the user wishes to consider. For instance, referring to FIG. 4C, a user may specify a viewing criterion 442 with only three hierarchical levels, where the first hierarchical level represents authors of artifacts, the second hierarchical level represents the creation year of artifacts, and the third hierarchical level represents the creation month of artifacts. Thus, a user wishing to access an artifact 202a stored within an archive 204 may navigate through a series of directories and subdirectories, first by selecting the logical label 308c representing the archive 204, then by selecting a directory 402i representing the author of the artifact 202a, then by selecting a subdirectory 402j representing the year that the artifact 202a was created, then by selecting a subdirectory 402k representing the month that the artifact 202a was created. Other artifacts that share the same author, creation year, and creation month as the artifact 202a (for instance, other artifacts 202b and 444a-b) are displayed in the same hierarchical location as the artifact 202a. In this manner, the user may restructure the viewing structure based on an arbitrary number (e.g., any number chosen by the user and supported by the system) of desired characteristics, such that artifacts are displayed within a viewing structure having an arbitrary number of hierarchical levels.

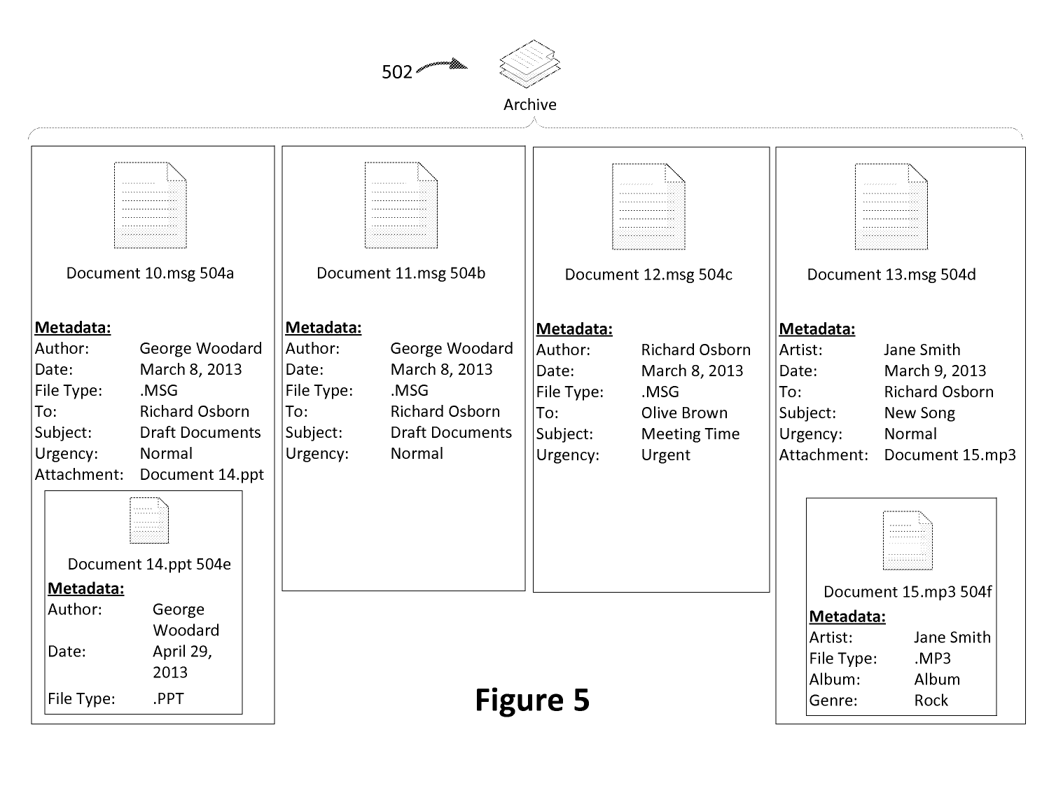

In some implementations, a user may use the system 100 to view artifacts representing email messages and files attached to the email messages. For instance, referring to FIG. 5, an archive 502 may contain several artifacts 504a-f, where some artifacts 504a-d represent email messages, and some other artifacts 504e and 504f represent files attached to the artifacts 504a and 504d, respectively. In some examples, each artifact includes metadata that describes one or more properties of the artifact. For example, an artifact 504a may contain metadata that specifies the author of the message, the date that the message was sent, the recipient of the message, the subject of the message, the urgency level of the message, and the files attached to the message. In another example, an artifact 504e represents a presentation, and may contain metadata that specifies the author of the presentation, the date that the presentation was created, and the file type of the artifact. While specific examples of metadata are described above, in some examples metadata can describe any property of the artifact, and are not limited by the above examples.

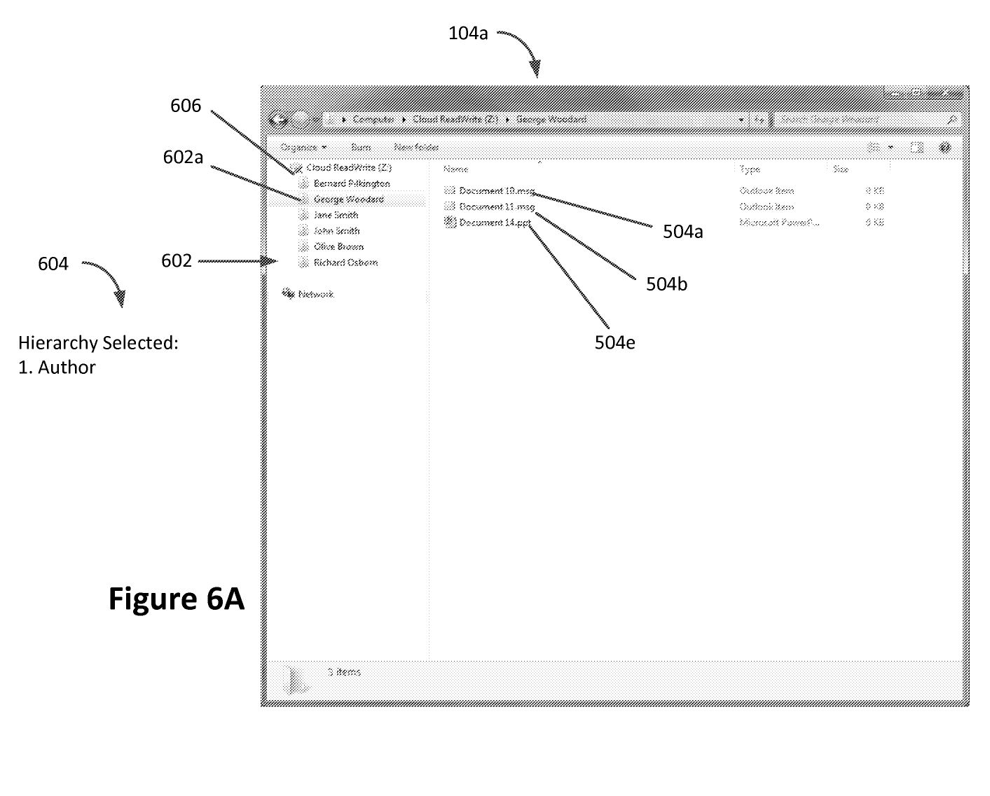

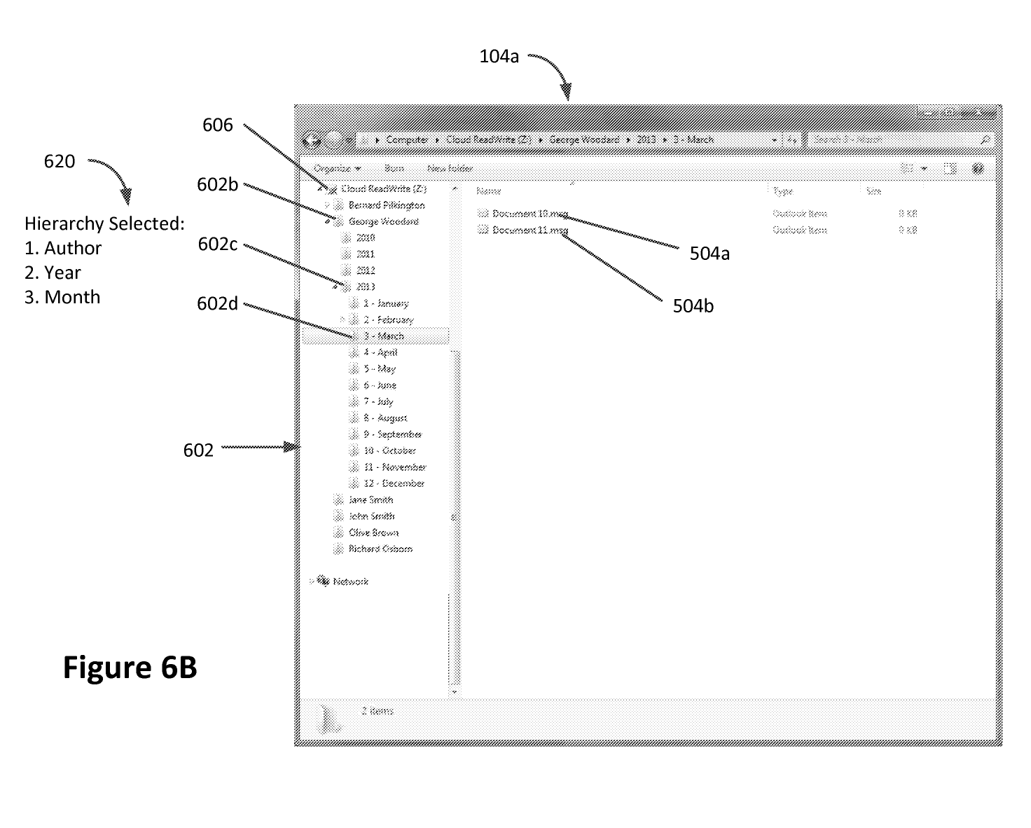

FIG. 6A shows an example of a user interface 104a used to access the contents of archive 502. A user interface 104a may display artifacts with respect to a particular viewing structure, where the viewing structure includes one or more hierarchical directories 602. For example, artifacts 504a, 504b, and 504e may be visually represented within an arrangement of directories 602.

The viewing structure may be dynamically generated based on user selected viewing criteria, such that the hierarchical directories 602 and the location of the artifacts within the directories are dynamically generated. For instance, a user may specify a viewing criterion 604 with a single hierarchical level representing the authors of artifacts. Thus, a user wishing to access an artifact 504a stored within an archive 502 may navigate through a series of directories and subdirectories, first by selecting the logical label 606 representing the archive 502, then by selecting a directory 602a representing the author of the artifact 504a. As some of the artifacts 504b and 504e share the same author as another artifact 504a, those artifacts 504b and 504e are displayed in the same hierarchical location as the other artifact 504a. In this manner, the user navigates the user interface 104a as if artifacts were stored in a hierarchical file structure, where each directory filters files according to particular characteristic.

In some implementations, the user may further refine display of artifacts by issuing a command to restructure the viewing structure based on another user selected viewing criterion, such that the hierarchical directories 602 and the location of the artifacts within the directories are dynamically re-generated. For instance, referring to FIG. 6B, a user may specify another viewing criterion 620, where a first hierarchical level represents the authors of artifacts, the second hierarchical level represents the creation year of artifacts, and the third hierarchical level represents the creation month of artifacts. Thus, a user wishing to access an artifact 504a stored within an archive 502 may navigate through the restructured series of directories and subdirectories, first by selecting the logical label 606 representing the archive 502, then by selecting a directory 602b representing the author of the artifact 504a, then by selecting a subdirectory 602c representing the year that artifact the artifact 504a was created, then by selecting subdirectory 602d representing the month that the artifact 504a was created. As another artifact 504b shares the same author, creation year, and creation month as the artifact 504a, the artifact 504b is displayed in the same hierarchical location as the artifact 504a. In addition, as the artifact 504e was created in a different month than the artifact 504a, the artifact 504e is no longer displayed in the same hierarchical location as the artifact 504a. Thus, a user may specify different viewing criterion to filter or broaden the display of artifacts.

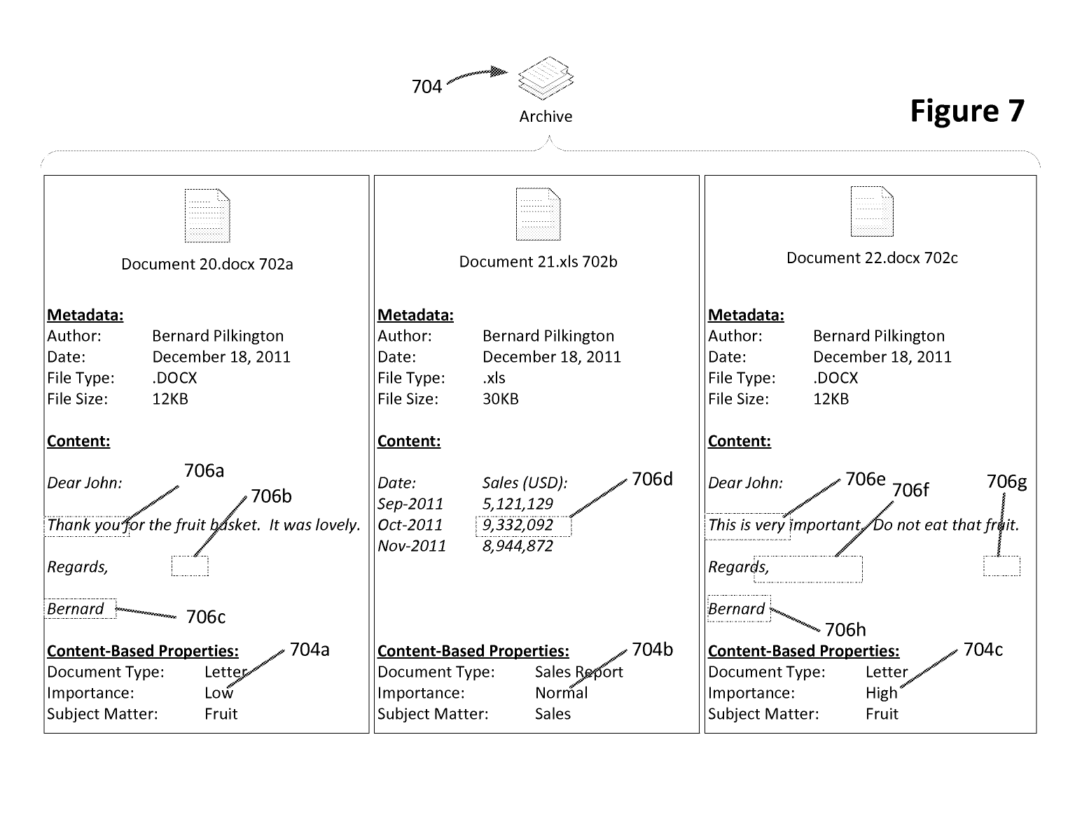

In some examples, the viewing structure may be dynamically generated based on any information that describes the artifacts. This is not limited solely to information contained within metadata. For instance, the viewing structure may be dynamically generated based on, either additionally or alternatively, implicit information determined about each artifact. This information may be determined in various ways, e.g., using an algorithmic technique. FIG. 7 shows an example of three artifacts 702a-c stored within a single archive 704. Several different types of artifacts may be stored within the same archive. For example, archive 704 includes artifacts of differing file types, including word processing documents (702a and 702c) and spreadsheets (702b). In some examples, each artifact includes metadata that describes one or more properties of the artifact. For example, the artifacts 702a-c may contain metadata that specifies the author of the artifact, the date that the artifact was created, and the file type of the artifact. Each artifact may be further described by one or more content-based properties 704a-c that are determined by the system 100 based on characteristics of the artifacts 702a-c. For example, content-based properties 704a may describe the type or style of document that the artifact 702a represents, the importance of the artifact, and the subject matter of the artifact.

Content-based properties may be determined in various ways, for instance by parsing and interpreting content of each artifact. In an example, the system 100 may parse the content of each artifact in order to identify key words or phrases in order to determine semantic meaning of the content. For example, the system 100 may recognize textual elements 706a and 706c as being common textual elements used in a letter of correspondence. Based on this determination, the system 100 may identify that the artifact 702a represents a letter of correspondence, and thus defines content-based properties 704a to include this classification. Further, the system 100 may recognize another textual element 706b as being the subject matter of the artifact 702a, and may further define content-based properties 704a to include this additional classification.

In a similar manner, content-based properties may be determined for other types of artifacts. For example, for an artifact 702b that represents a spreadsheet, the system 100 may recognize a cell element 706d as a cell element commonly used in sales reports. Based on this determination, the system 100 may identify that the artifact 702b represents a sales report, and thus defines content-based properties 704b to include this classification. In a similar manner, the system 100 may also determine that the artifact 702b contains sales related subject matter. In some implementations, the system 100 may make these determinations using one or more algorithms, such as automatic classification algorithms, taxonomy generation algorithms, algorithms based on Bayesian analysis techniques, algorithms based on natural language processing techniques, or other algorithms for identifying and categorizing data.

In another example, the system 100 may parse the content of an artifact 702c and recognize some other textual elements 706e and 706h as being common textual elements used in a letter of correspondence. Based on this determination, the system 100 may identify that the artifact 702c represents a letter of correspondence, and thus defines content-based properties 704c to include this classification. Further, the system 100 may recognize another textual element 706g as being the subject matter of the artifact 702c, and may further define content-based properties 704c to include this additional classification. Further still, the system 100 may recognize yet another textual element 706f as being an indicator for the relative importance of the artifact 702c, and may further define content-based properties 704c to include this additional classification.

While above examples illustrate how the content of each artifact can be used to determine the implicit content-based properties of each artifact, this determination is not limited to the above described techniques. In addition to recognizing key words or phrases, the system 100 may consider other semantic factors, such as the proximity of key words or phrases to other key words or phrases, the presence and location of punctuation, and syntactical patterns. Any technique for identifying characteristics of an artifact could be used, and those characteristics can be used as selection criteria.

In some implementations, the system 100 may also consider databases containing the semantic information of words or phrases based upon a specific domain of usage. For instance, the system 100 may interpret a textual element “broke” in the domain of maintenance, and ascertain that this textual element refers to a mechanical failure. The system 100 may also interpret the textual element “broke” in the domain of finance, and ascertain that this textual element refers to a lack of financial funds. In this manner, the system 100 may accurately determine one or various content-based properties based on the context of the content.

In some implementations, the system 100 may also consider metadata in determining the implicit content-based properties. For instance, the system 100 may recognize a particular user's tendency to create sales documents, and may be more likely to assign a sales related classification to artifacts authored by that user. Other techniques may be employed, such as those commonly utilized in natural language processing techniques.

In some implementations, the system 100 may dynamically generate a viewing structure that groups artifacts of different properties together at a single hierarchical level. In an example, one or more artifacts may contain biographical and vital data about one or more corresponding people, and may include data such as gender, age, height, hair color, eye color, musical talents, hobbies, place of birth, residence, and so forth. A user may specify a particular viewing criterion, such that a user interface 104a displays artifacts according to a desired hierarchical organization. For instance, a user may specify a single hierarchical level that represents a person's age. However, instead of displaying individual subdirectories for each integer age, the system 100 may group several ages together in groups. For instance, a subdirectory may represent ages from 0-17, another subdirectory may represent ages from 18-34, another subdirectory may represent ages from 35-50, and so forth. This allows for an organizational simplification of the user interface 104a, and allows a user to more easily find artifacts with similar, but distinct properties. In some implementations, the system 100 algorithmically determines if a hierarchical level should be grouped in this manner, or if each individual properties should be displayed as an individual subdirectory. In some implementations, the system 100 considers one or more criteria in making a determination, for instance the number of different individual properties of the artifacts, whether a contextually relevant grouping is appropriate (e.g. common age groupings, similar hobbies, residence in close geographical proximity, etc.), user input, or other such criteria. In some implementations, the system 100 may toggle between grouped and ungrouped viewing structures, such that a user may select a preferred viewing structure.

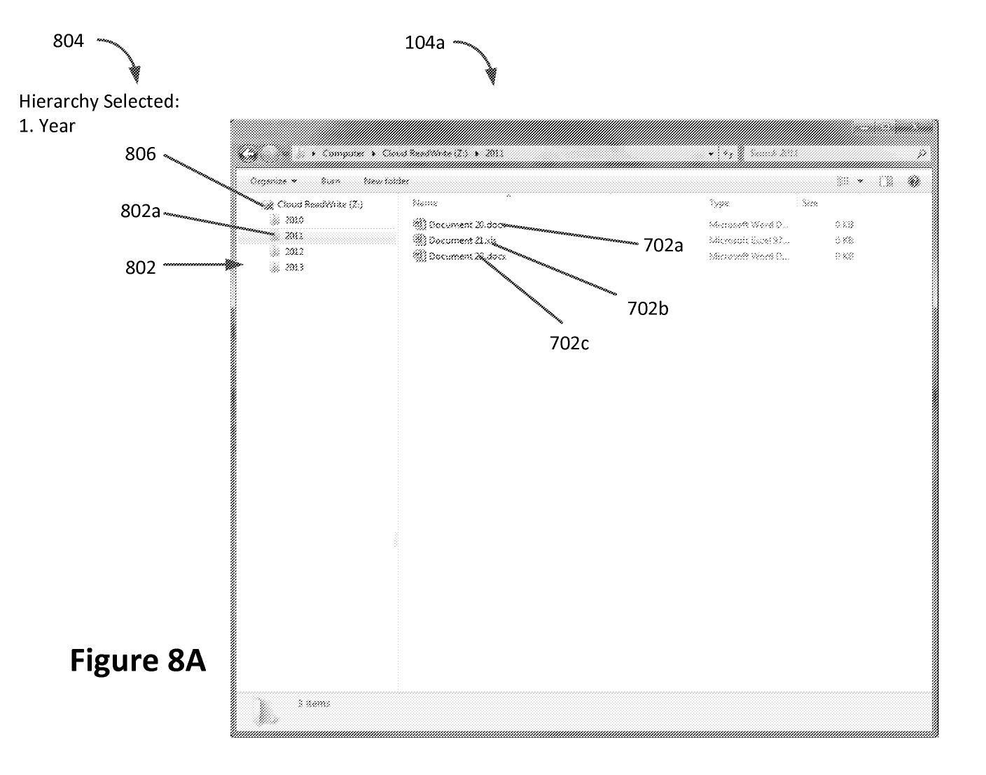

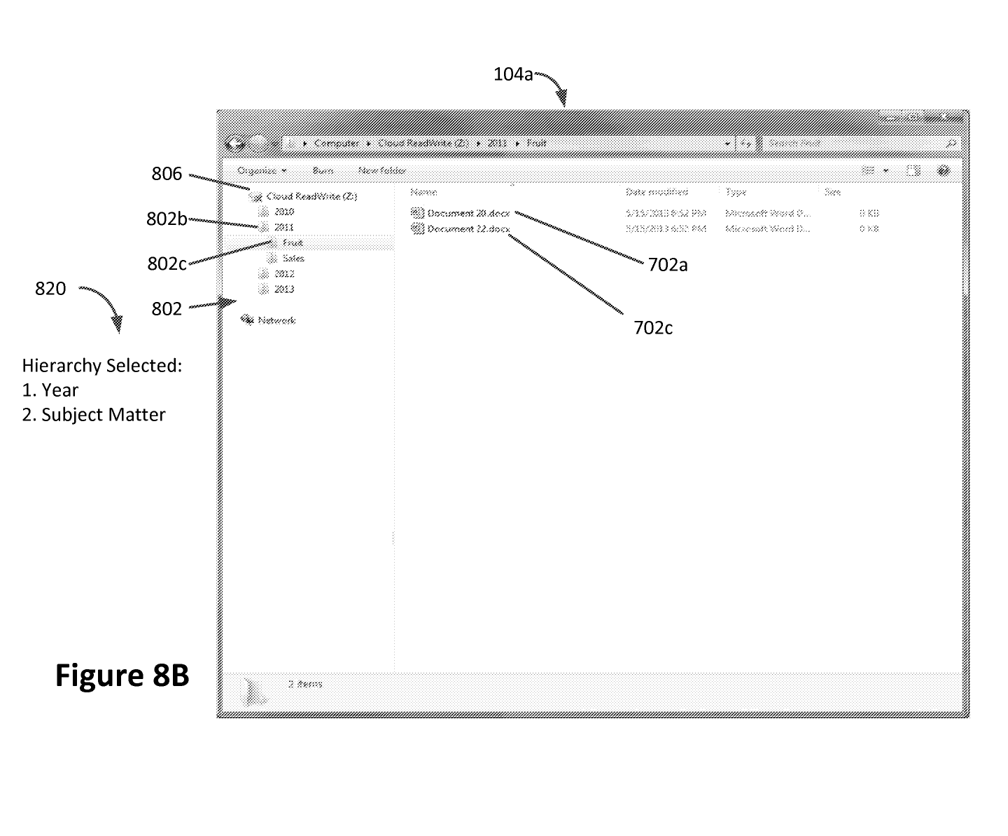

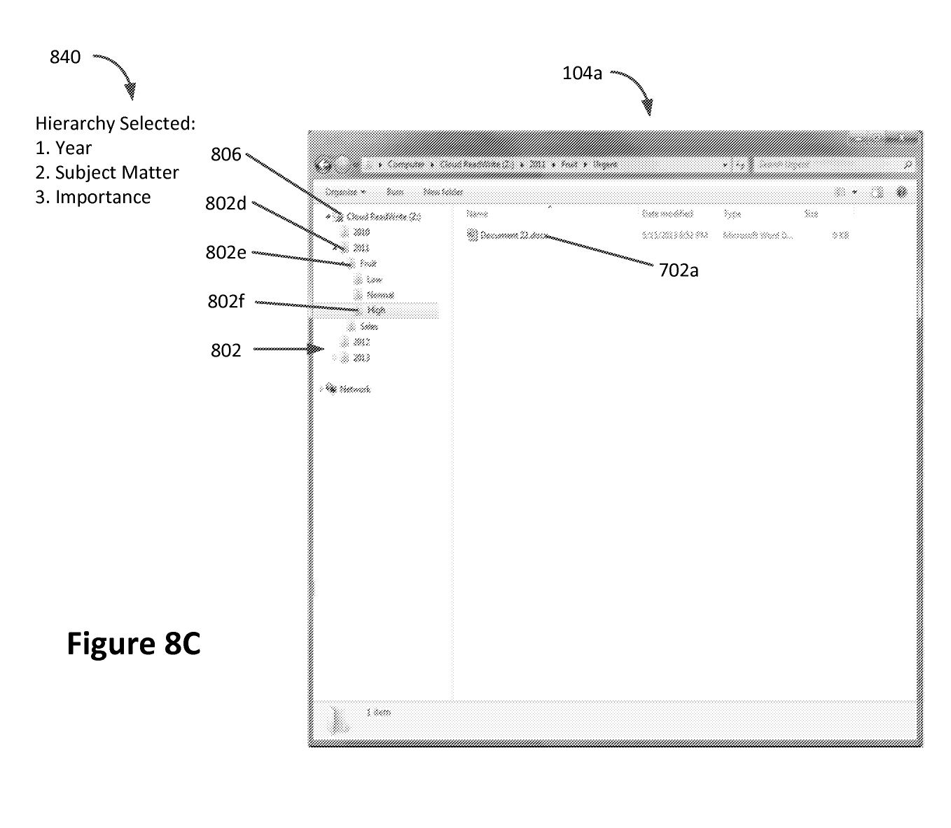

FIG. 8A shows an example of a user interface 104a used to access the contents of the archive 704. The user interface 104a may display artifacts with respect to a particular viewing structure, where the viewing structure includes one or more hierarchical directories 802. For example, artifacts 702a-c may be visually represented within an arrangement of directories 802. The viewing structure may be dynamically generated based on user selected viewing criteria, such that the hierarchical directories 802 and the location of the artifacts within the directories are dynamically generated. For instance, a user may specify a viewing criterion 804 with a single hierarchical level representing the year that the artifacts were sent. Thus, a user wishing to access an artifact 702a stored within an archive 704 may navigate through a series of directories and subdirectories, first by selecting the logical label 806 representing the archive 704, then by selecting a directory 802a representing the year in which the artifact 702a was sent. Other artifacts that were sent in the same year as the artifact 702a (for instance, other artifacts 702b-c) are displayed in the same hierarchical location as the artifact 702a. In this manner, the user navigates the user interface 104a as if artifacts were stored in a hierarchical file structure, where each directory filters files according to particular characteristic.

In some implementations, the user may further refine display of artifacts by issuing a command to restructure the viewing structure based on another user selected viewing criterion, such that the hierarchical directories 802 and the location of the artifacts within the directories are dynamically re-generated. For instance, referring to FIG. 8B, a user may specify another viewing criterion 820, where a first hierarchical level represents the year in which the artifact was sent, and the second hierarchical level represents the implicitly determined subject matter of the artifact. Thus, a user wishing to access an artifact 702a stored within an archive 704 may navigate through the restructured series of directories and subdirectories, first by selecting the logical label 806 representing the archive 702, then by selecting a directory 802b representing the year in which the artifact 702a was sent, then by selecting a subdirectory 802c representing the subject matter of the artifact 702a. As another artifact 702c was sent in the same year as the artifact 702a and shares the same subject matter, the other artifact 702c is displayed in the same hierarchical location as the artifact 702a. In addition, as the artifact 702b deals with different subject matter than the artifact 702a, the artifact 702b is no longer displayed in the same hierarchical location as the artifact 702a. Thus, a user may specify different viewing criterion to filter or broaden the display of artifacts.

In some implementations, the user may further refine display of artifacts. For instance, referring to FIG. 8C, a user may specify another viewing criterion 840, where a first hierarchical level represents the year in which the artifact was sent, the second hierarchical level represents the implicitly determined subject matter of the artifact, and the third hierarchical level represents the implicitly determined importance of the artifact. Thus, a user wishing to access an artifact 702a stored within an archive 704 may navigate through the restructured series of directories and subdirectories, first by selecting the logical label 806 representing the archive 702, then by selecting a directory 802d representing the year in which the artifact 702a was sent, then by selecting a subdirectory 802e representing the subject matter of the artifact 702a, then by selecting a subdirectory 802f representing the importance of the artifact 702a. As no other artifacts were sent in the same year as the artifact 702a, and that are also relevant to the same subject matter as the artifact 702a, and that have the same level of importance as the artifact 702a, the artifact 702a is displayed alone in its hierarchical location. Thus, a user may continue to refine the selected different viewing criterion to successively filter or broaden the display of artifacts.

In some implementations, one or more user selected viewing criteria may be saved in the form of templates, such that a user may quickly switch between one or more saved templates instead of individually specifying each characteristic of a user selected criterion. A user may select from among these templates either instead of, or in addition to individually specifying each characteristic of a user selected criterion. As an example, viewing criteria 804, 820, and 840 may be saved as templates, and a user may select between viewing templates representing criteria 804, 820, and 840 instead of specifying each individual characteristic (e.g. the date of creation, the author, the file type, etc.) of a viewing criteria. In another example, viewing criteria 804, 820, and 840 may be saved as templates, and a user may specify individual characteristics of a viewing criteria unrelated to those of the saved templates.

In some implementations, a user may selectively create, modify, and delete templates. As an example, a user may create a template from viewing criteria 804, with a single hierarchical level representing the year that the artifacts were sent. The user may modify the template, for instance by specifying a second hierarchical level representing the author of the artifacts. The user may further modify the template, for instance by specifying that the first hierarchical level instead represents the implicitly determined subject matter of the artifact. When the user no longer wishes to retain this template, the user may delete this template. In some implementations, a user may specify a preferred template, such that the user interface 102a defaults to a specified viewing structure unless the user specifies otherwise.

In some implementations, the system 100 assigns permission to each user with regard to each archive 106a-e so that each user is permitted to view some or all of the archives 106a-e, is permitted to both read and write to some or all of the archives 106a-e, and is not allowed to read or write to some or all of the archives 106a-e. These permissions may be defined and maintained according to one or more security policies established by an administrator or supervisor. In some implementations, an administrator or supervisor may revoke a specific user's permissions, such that the user no longer has read or write permission to regard to some or all of the archives 106a-e.

In some implementations, all or part of the archives 106a-e may be duplicated and stored locally on the client computer of a user accessing the archives 106a-e. In some implementations, the archives 106a-e are temporarily stored locally in order to cache recently accessed artifacts or frequently accessed artifacts. In some implementations, duplicates of the archives 106a-e are permanently stored locally. In some implementations, a user interacts with a user interface to access a locally stored duplicate archive, and the system 100 synchronizes any modifications to the locally stored duplicate archive to the remotely stored original archive. For example, a user may use a user interface 104a to access an archive 106e stored on a cloud system 110. The system 100 duplicates all or part of the archive 106e to the user's client computer 102a, and the user uses the user interface 104a to access the locally stored duplicate archive. If the user modifies any portion of the locally stored duplicate archive, the modifications are synchronized to the original archive 106e to ensure data fidelity.

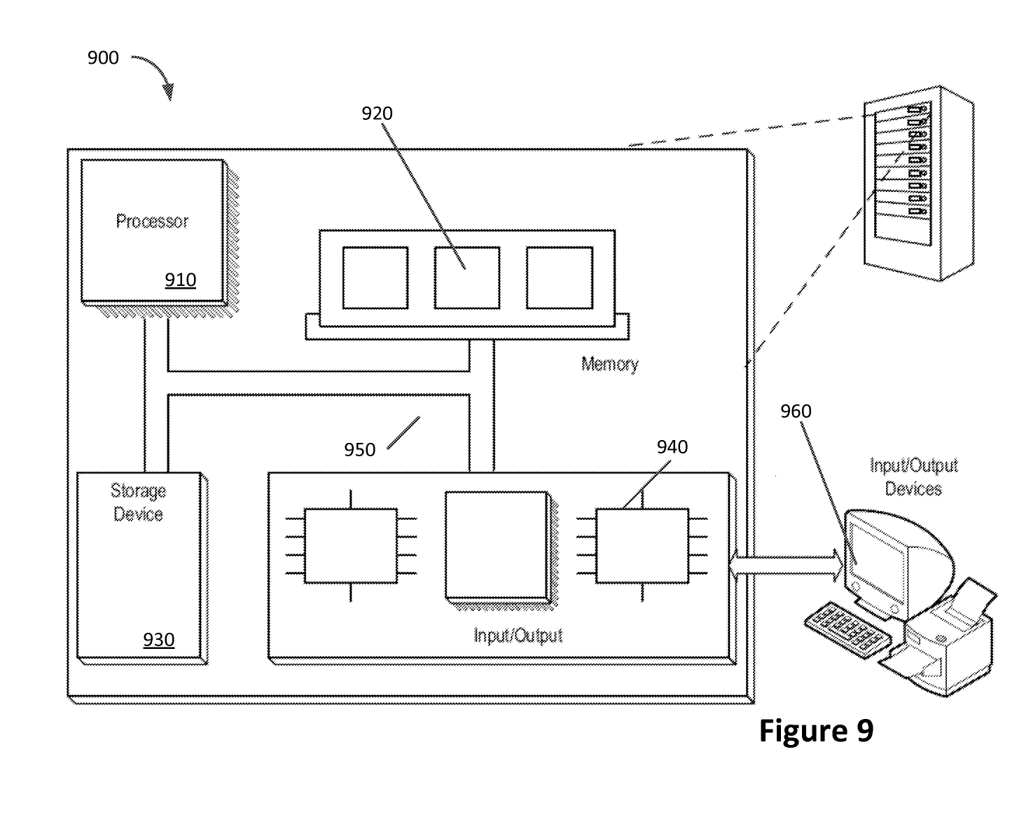

FIG. 9 is a block diagram of an example computer system 900. For example, referring to FIG. 1, client computers 102a-c, a file server 108, a cloud system 110, or a server forming a portion of the cloud system 110 could be an example of the system 900 described here, as could a computer system used by any of the users who access resources of client computers 102a-c, the file server 108, or the cloud system 110. The system 900 includes a processor 910, a memory 920, a storage device 930, and an input/output device 940. Each of the components 910, 920, 930, and 940 can be interconnected, for example, using a system bus 950. The processor 910 is capable of processing instructions for execution within the system 900. In some implementations, the processor 910 is a single-threaded processor. In some implementations, the processor 910 is a multi-threaded processor. In some implementations, the processor 910 is a quantum computer. The processor 910 is capable of processing instructions stored in the memory 920 or on the storage device 930. The processor 910 may execute operations such as storing, maintaining, and displaying artifacts.

The memory 920 stores information within the system 900. In some implementations, the memory 920 is a computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 can include, for example, a hard disk device, an optical disk device, a solid-date drive, a flash drive, magnetic tape, or some other large capacity storage device. In some implementations, the storage device 930 may be a cloud storage device, e.g., a logical storage device including multiple physical storage devices distributed on a network and accessed using a network. In some examples, the storage device may store long-term data, such as the artifacts 101 or archives 106a-e. The input/output device 940 provides input/output operations for the system 900. In some implementations, the input/output device 940 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. A network interface device allows the system 900 to communicate, for example, transmit and receive data such as artifacts 101 or archives 106a-e shown in FIG. 1. In some implementations, the input/output device can include driver devices configured to receive input data and send output data to other input/output devices, e.g., keyboard, printer and display devices 960. In some implementations, mobile computing devices, mobile communication devices, and other devices can be used.

A server (e.g., a file server 108, a cloud system 110, or a server forming a portion of the cloud system 110 shown in FIG. 1) can be realized by instructions that upon execution cause one or more processing devices to carry out the processes and functions described above, for example, storing, maintaining, and displaying artifacts. Such instructions can include, for example, interpreted instructions such as script instructions, or executable code, or other instructions stored in a computer readable medium. A file server 108 or a cloud system 110 can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 9, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as storing, maintaining, and displaying artifacts can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server (e.g., a cloud system 110) is a general purpose computer, and sometimes it is a custom-tailored special purpose electronic device, and sometimes it is a combination of these things. Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

What is claimed is:

1. A computer-implemented method comprising:
receiving, from a user, a first criterion for arranging a set of artifacts in a first hierarchy comprising a first arrangement, the artifacts being stored in an archive in a second arrangement; and
displaying, in a user interface, a level of the first hierarchy comprising a subset of the artifacts, the subset of the artifacts having a common feature identified based on the first criterion.

2. The method of claim 1, comprising receiving, from the user a second criterion for arranging the set of artifacts in a second hierarchy comprising a second arrangement, and
displaying, in the user interface, a level of the second hierarchy comprising a second subset of the artifacts, the second subset of the artifacts having a common feature identified based on the second criterion.

3. The method of claim 1, comprising receiving, from the user a plurality of criteria for arranging the set of artifacts in a plurality of corresponding levels of the first hierarchy, each level comprising a different arrangement of the artifacts, and
displaying, in the user interface, one of the levels of the first hierarchy comprising a subset of the artifacts, the subset of the artifacts having a common feature identified based on one of the plurality of criteria.

4. The method of claim 3, wherein the first criterion is among the plurality of criteria

5. The method of claim 1, wherein the level of the hierarchy is displayed in the form of a directory, the directory comprising a portion of a logical drive available to a computer system operated by the user.

6. The method of claim 1, wherein the set of artifacts comprises a set of email messages and attachments each associated with at least one of the email messages.

7. The method of claim 1, wherein the first hierarchy comprises a directory structure of folders and files stored within the respective folders, the files comprising at least some of the artifacts of the set of artifacts.

8. The method of claim 1, wherein the common feature is identified based on identifying similarities among metadata associated with the respective artifacts of the subset, the metadata comprising data other than data describing a storage location of the respective artifacts.

9. The method of claim 1, wherein the common feature is identified based on an identification of semantic similarities among content of the respective artifacts.

10. The method of claim 9, wherein the common feature is identified based on a combination of semantic similarities among the content of the respective artifacts and similarities among metadata associated with the respective artifacts of the subset, the metadata comprising data other than data describing a storage location of the respective artifacts.

11. The method of claim 1, wherein the first hierarchy comprises a plurality of levels, wherein each level corresponds to a different characteristic of the first criterion.

12. The method of claim 1, comprising receiving the first criterion in the form of a template previously established by a user.

13. The method of claim 1, wherein the level of the hierarchy is displayed in the form of a hierarchical outline.

14. A computer readable storage device storing software comprising instructions executable by a computer system to cause the computer system to perform operations comprising:
receiving, from a user, a first criterion for arranging a set of artifacts in a first hierarchy comprising a first arrangement, the artifacts being stored in an archive in a second arrangement; and
displaying, in a user interface, a level of the first hierarchy comprising a subset of the artifacts, the subset of the artifacts having a common feature identified based on the first criterion.

15. The computer readable storage device of claim 14, the operations further comprising
receiving, from the user a second criterion for arranging the set of artifacts in a second hierarchy comprising a second arrangement, and
displaying, in the user interface, a level of the second hierarchy comprising a second subset of the artifacts, the second subset of the artifacts having a common feature identified based on the second criterion.

16. The computer readable storage device of claim 14, the operations further comprising
receiving, from the user, a plurality of criteria for arranging the set of artifacts in a plurality of corresponding levels of the first hierarchy, each level comprising a different arrangement of the artifacts, and
displaying, in the user interface, one of the levels of the first hierarchy comprising a subset of the artifacts, the subset of the artifacts having a common feature identified based on one of the plurality of criteria.

17. The computer readable storage device of claim 16, wherein the first criterion is among the plurality of criteria.

18. The computer readable storage device of claim 14, wherein the level of the hierarchy is displayed in the form of a directory, the directory comprising a portion of a logical drive available to a computer system operated by the user.

19. The computer readable storage device of claim 14, wherein the set of artifacts comprises a set of email messages and attachments each associated with at least one of the email messages.

20. The computer readable storage device of claim 14, wherein the first hierarchy comprises a directory structure of folders and files stored within the respective folders, the files comprising at least some of the artifacts of the set of artifacts.

21. The computer readable storage device of claim 14, wherein the common feature is identified based on identifying similarities among metadata associated with the respective artifacts of the subset, the metadata comprising data other than data describing a storage location of the respective artifacts.

22. The computer readable storage device of claim 14, wherein the common feature is identified based on an identification of semantic similarities among content of the respective artifacts.

23. The computer readable storage device of claim 22, wherein the common feature is identified based on a combination of semantic similarities among the content of the respective artifacts and similarities among metadata associated with the respective artifacts of the subset, the metadata comprising data other than data describing a storage location of the respective artifacts.

24. The computer readable storage device of claim 14, wherein the first hierarchy comprises a plurality of levels, wherein each level corresponds to a different characteristic of the first criterion.

25. The computer readable storage device of claim 14, the operations further comprising receiving the first criterion in the form of a template previously established by a user.

26. The computer readable storage device of claim 14, wherein the level of the hierarchy is displayed in the form of a hierarchical outline.

27. A system comprising:
a computer system configured to:
receive, from a user, a first criterion for arranging a set of artifacts in a first hierarchy comprising a first arrangement, the artifacts being stored in an archive in a second arrangement; and
display, in a user interface, a level of the first hierarchy comprising a subset of the artifacts, the subset of the artifacts having a common feature identified based on the first criterion.

28. The system of claim 27, the computer system configured to receive, from the user a second criterion for arranging the set of artifacts in a second hierarchy comprising a second arrangement, and
display, in the user interface, a level of the second hierarchy comprising a second subset of the artifacts, the second subset of the artifacts having a common feature identified based on the second criterion.

29. The system of claim 27, the computer system configured to receive, from the user a plurality of criteria for arranging the set of artifacts in a plurality of corresponding levels of the first hierarchy, each level comprising a different arrangement of the artifacts, and
display, in the user interface, one of the levels of the first hierarchy comprising a subset of the artifacts, the subset of the artifacts having a common feature identified based on one of the plurality of criteria.

30. The system of claim 29, wherein the first criterion is among the plurality of criteria

31. The system of claim 27, wherein the level of the hierarchy is displayed in the form of a directory, the directory comprising a portion of a logical drive available to a computer system operated by the user.

32. The system of claim 27, wherein the set of artifacts comprises a set of email messages and attachments each associated with at least one of the email messages.

33. The system of claim 27, wherein the first hierarchy comprises a directory structure of folders and files stored within the respective folders, the files comprising at least some of the artifacts of the set of artifacts.

34. The system of claim 27, wherein the common feature is identified based on identifying similarities among metadata associated with the respective artifacts of the subset, the metadata comprising data other than data describing a storage location of the respective artifacts.

35. The system of claim 27, wherein the common feature is identified based on an identification of semantic similarities among content of the respective artifacts.

36. The system of claim 35, wherein the common feature is identified based on a combination of semantic similarities among the content of the respective artifacts and similarities among metadata associated with the respective artifacts of the subset, the metadata comprising data other than data describing a storage location of the respective artifacts.

37. The system of claim 27, wherein the first hierarchy comprises a plurality of levels, wherein each level corresponds to a different characteristic of the first criterion.

38. The system of claim 27, wherein the computer system is configured to receive the first criterion in the form of a template previously established by a user.

39. The system of claim 27, wherein the level of the hierarchy is displayed in the form of a hierarchical outline.
